(19) United States
(12) Patent Application Publication
(10) Pub. No.: US 2008/0177495 A1
(43) Pub. Date: Jul. 24, 2008

(54) AUTOMATED MEASUREMENT DERIVATION

(76) Inventor: Josh Todd Gold, Newport Coast, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/015,455

(22) Filed: Jan. 16, 2008

Related U.S. Application Data
(60) Provisional application No. 60/885,890, filed on Jan. 20, 2007.

(51) Int. Cl. G01D 1/00; G01C 21/16

(52) U.S. Cl. 702/127; 701/207; 701/213

(57) ABSTRACT

A system and method for deriving an estimated measurement from the basis of acquired real world measurements is provided. The system and method include establishing a relationship between the components of the estimated measurement and the components of the acquired real world measurements, and where the algorithms express the value component of the estimated measurement in terms of a combination of the other components of the estimated measurement and the components of the acquired real world measurements.

### CROSS-REFERENCE TO RELATED APPLICATIONS

This application claims priority from U.S. Provisional Application Ser. No. 60/885,890, filed Jan. 20, 2007, which is incorporated herein by this reference in its entirety.

### TECHNICAL FIELD

This invention relates generally to measurement data, and more particularly some embodiments relate to producing substitutes for missing, erroneous, or anomalous real world measurements.

### DESCRIPTION OF THE RELATED ART

There are numerous scenarios where real world measurements may be lost during a data acquisition process. A failure at any point in the data acquisition process may result in lost or erroneous real world measurements. Examples of failure scenarios include, but are not limited to, equipment related problems such as improper installation, design flaw, manufacturing flaw or communication related problems such as broken communication medium, overloaded communication channel, or excessively noisy communication channel.

Existing methods of dealing with measurement failures resulting in real world measurement loss typically involve methods to recreate the exact measurement data which was lost. Typically, exact data replacement is required because the usage of inexact data, incorrect by a potentially unknown or substantial margin, may compromise the means for which the data is being used. Means for recreating lost data may involve redundancy, where failure at some failure point in the real world measurement system is compensated for by using a redundant working corresponding failure point. Examples of such redundancy include redundant measuring devices, redundant measurement communication means, and redundant measurement data collection devices. Such redundancy also includes transmitting redundant or error correction data which may be used to recreate missing real world measurement data.

### BRIEF SUMMARY OF EMBODIMENTS OF THE INVENTION

According to various embodiments of the invention, a method, apparatus, or system is provided to generate an estimated replacement measurement for data missing from the data acquisition process. This allows functions that rely on the data acquisition process to operate uninterrupted and with increased accuracy and reliability. Measurements data may be missing for a variety of reasons, including, but not limited to, equipment error, improper usage, or environmental failure.

A measurement originated data source, which is missing the originating measurements, may be estimated by algorithmic inference using some combination of one or more other available measurement originated data sources, knowledge of the physical circumstances within which the real world measurements are obtained, and other data sources as available.

According to one embodiment of the present invention, a real world measurement determined aspect of a computer simulation of a real world event may continue to be simulated in a substantially accurate state while some or all of the source real world measurements for the aspect are unavailable.

Also, according to the present invention, a nonexistent real world measurement stream is provided with estimated replacement measurements, thereby allowing functions which rely on the real world measurements to operate uninterrupted and with increased perceived accuracy and believability. Real world measurement may be nonexistent for a variety of reasons, including, but not limited to, because a measuring device for performing the real world measurements was not installed.

A simulated measurement originated data source, which does not have the originating measurements by design, may be estimated by algorithmic inference using some combination of one or more other available measurement originated data sources, knowledge of the physical circumstances within which the real world measurement are obtained, and other data sources as available.

According to one embodiment of the present invention, a real world measurement determined aspect of a computer simulation of a real world event may be simulated in a substantially accurate state when the source real world measurements for the aspect do not exist.

Also according to the present invention, a real world measurement stream is provided with increased real or simulated accuracy, thereby allowing functions which rely on the real world measurement to operate with increased perceived accuracy and believability.

A measurement originated data source may be provided with real or simulated increased fidelity by deriving the increased fidelity using algorithmic inference from some combination of one or more other available measurement originated data sources, knowledge of the physical circumstances within which the real world measurements are obtained, and other data sources as available.

According to one embodiment of the present invention, a real world measurement determined aspect of a computer simulation of a real world event may be simulated with plausibly increased accuracy using additional other available real world measurements.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates relevant components of an exemplary application using the present invention.

FIG. 2 illustrates an example scenario during use of an exemplary application using the present invention.

FIG. 3 illustrates data flow from real world measurement streams to measurement originated data sources for an exemplary application using the present invention.

FIG. 4 illustrates an example computer system in which an embodiment of the present invention can be implemented.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

### 1. Definitions

Before describing the invention in detail, it is useful to define some of the terms found herein.

Data source may include a plurality of state values representing the states of a real world measurable quality of a real world object over a first real world clock time span, where each said state value represents the state of said real world measurable quality of said real world object over a corresponding second real world clock time span, and where said first real world clock time span encloses all said second real world clock time spans.

Measurement originated data source may include a data source whose state values originate from first real world measurements, where each said state value is either
a real world measurement from said first real world measurements, where said state value and said real world measurement share the same real world measurable quality and real world object,
derived from one or more of said first real world measurements, where said state value and said one or more first real world measurements share the same real world measurable quality and real world object, or
produced by measurement derivation, where the originating measurements of said measurement derivation are one or more of said first real world measurements.

Originating measurements may include a data collection process that collects data, or a measurement of a measurement originated data source, or a measurement of a measurement derivation.

Originating measurements may include the real world measurements of a measurement originated data source, or the real world measurements of a measurement derivation.

Measurement derivation may include the production of a state value for a measurement originated data source, where the state value is derived by algorithmic inference utilizing a combination of
collected data,
a real world measurement of the originating measurements of the measurement originated data source,
a state value of an other measurement originated data source, or
algorithms incorporating one or more of
   knowledge of the physical circumstances within which the real world measurements of any the originating measurements or any other measurement originated data sources is obtained, or
   knowledge of the physical circumstances within which the real world measurement of the state value would have been obtained, had such a real world measurement of the real world measurable quality of the state value occurred.

Missing measurement mode may include the augmentation of a measurement originated data source using measurement derivation, where one or more additional state values for the measurement originated data source are produced using measurement derivation.

Nonexistent measurement mode may include the creation of a measurement originated data source using measurement derivation, where all state values for said measurement originated data source are produced using measurement derivation.

Increased fidelity mode may include the correction of a measurement originated data source using measurement derivation, where for one or more state values of the measurement originated data source, each state value from the one or more state values is subject to actions comprising one or more of
anomalous value detection by comparison of the state value with value produced using measurement derivation,
anomalous value replacement by replacing the state value identified as anomalous by the anomalous value detection with value produced using measurement derivation, or
value accuracy enhancement by adjusting the state value using an adjustment value produced using measurement derivation.

Event depiction may include the representation of a narrative event from the event content core for the narrative event.

Event presentation may include the event depiction presented on presentation devices supplied with presentation content by presentation content production.

Presentation specification may include a description of the desired event depiction resulting from an event presentation.

Production characteristics may include characteristics which determine the style with which the event depiction is presented. Production characteristics do not change the history of the narrative event of the event depiction, where the history is originated from the event content core, but they do determine how the history is presented. Production characteristics may include, but are not limited to, the sequence of scenes with which each narrative event is presented, characteristics for each camera and for each audio counterpart to a camera, such as position and movement path, artistic resources, such as lighting, music, and commentary, event element depictive resources, such as object models and sound effects, and sensory output device rendering style.

Presentation device may include a device whose purpose includes producing sensory output detectable by at least one sense. The device is connected to one or more sources of content for the device by a communication means, and produces the sensory output depending on the content. Examples of such a device include, but are not limited to, a visual sensory output device, or display device, such as a television or monitor, and an audible sensory output device, or sound output device, such as a stereo or surround sound system.

Presentation content may include content in an encoding suitable for input to one or more presentation devices.

Production material may include one or more resources for use as input to one or more processes of the presentation content production, for use by the processes in the production of output resulting from that process.

Production instruction may include one or more rules specifying, controlling, or defining how production material is used in the operation of one or more processes of the presentation content production.

Production collection may include one or both of one or more production materials and one or more production instructions.

Rendering may include the resultant output from an operation of a renderer.

Simulator asset may include production material for use by a simulator. Simulator assets include, but are not limited to, a virtual world object, and data or algorithms for controlling aspects of the virtual world object.

Renderer asset may include production material for use by a renderer. A simulation is a renderer asset. Renderer assets may also include, but are not limited to, a model to use for a virtual world object for the rendering of that object.

Compositor asset may include production material for use by a presentation content compositor. A rendering is a compositor asset. Compositor assets may also include, but are not limited to, production material for use in overlaying, underlying, or replacing renderings, such as overlaying textual information or replacing videos for a display device, or overlaying narration or underlying music for a sound output device.

Simulator directive may include production instruction for use by a simulator. Simulator directives include, but are not limited to, control of the simulation temporal position, rate, or direction.

Renderer directive may include production instruction for use by a renderer. Renderer directives include, but are not limited to, control of which model to use for the rendering of a virtual world object, and the position and direction within the simulation from which a rendering is generated.

Compositor directive may include production instruction for use by a presentation content compositor. Compositor directives may also include, but are not limited to, control of the content selected for overlaying, underlying, or replacing renderings, and control of the placement of renderings within the presentation content.

Available production assets may include the available production materials which may be used by a presentation content production. Available production assets may include simulator assets, renderer assets, and compositor assets, and may also include other production material as needed or available.

Available production directives may include the available production instructions which may be used by a presentation content production. Available production directives may include simulator directives, renderer directives, and compositor directives, and may also include other production instructions as needed or available.

Available production collection may include the available production assets and available production directives for a given presentation content production.

Presentation collection may include event content core and a subset of the available production collection sufficient to enable an event presentation of a given presentation specification.

Presentation assets may include the subset of the available production assets used for the production materials portion of a presentation collection.

Presentation directives may include the subset of the available production directives used for the production instructions portion of a presentation collection.

Presentation operation may include the operation of an event presentation.

Presentation initiation may include the portion of the presentation operation where elements necessary for the presentation performance are made ready.

Presentation performance may include the portion of the presentation operation where the event depiction is presented on the presentation devices.

Presentation termination may include the portion of the presentation operation occurring after the presentation performance.

Renderer may include the process of converting an aspect of a simulation into a form compatible with a presentation device of a given type and capability. A typical render operation may be the conversion of the view from a given position in a given direction within a simulation to a form suitable for transmission to a display device, or the conversion of the soundscape from a given position in a given direction within a simulation to a form suitable for transmission to a sound output device.

Compositor may include the process of composing presentation content from one or both of one or more renderings and other production material.

Presentation content production pipeline component may include the functionality of the portion of the presentation operation producing presentation content from a presentation collection, where production characteristics are determined by the production material and production instructions supplied to the functionality, the functionality comprising functionality for the operation of: one or more simulators, controlled by simulator directives, using simulator assets, and producing one or more simulations; one or more renderers, controlled by renderer directives, using the one or more simulations and other renderer assets, and producing renderings; and one or more presentation content compositors, controlled by compositor directives, using the renderings and other compositor assets, and producing presentation content.

Presentation content production pipeline may include the operation of the presentation content production pipeline component.

Presentation content production may include the operation of producing presentation content for an event presentation, comprising the presentation content production pipeline.

Real world clock time span may include a span of clock time, bound by a start clock time and an end clock time, where the span is formed from a measurement of real world time, a duration of real world time, and an offset of real world time, such that the start clock time is equal to the sum of the measurement and the offset, and such that the end clock time is equal to the sum of the measurement, the offset, and the duration, and where the offset is either implicit or is explicitly measured, and where the duration is either implicit or is explicitly measured, and where the start clock time and the end clock time implicitly, explicitly, or effectively share a common time scale. Examples include, but are not limited to, May 16, 2006 1:45 PM to May 16, 2006 3:00 PM local time, and May 16, 2006 05:47:32.843 UTC with an implicit error range of plus or minus 4 milliseconds. Examples of the time scale include, but are not limited to, Greenwich Mean Time, Coordinated Universal Time, the local time scale of some time zone, or some time scale based on one or more clocks.

Real world object may include a physical object in the real world. Examples include, but are not limited to, a solid, liquid, or gas body, or some collection of said bodies, such as a car, a person, the surface of an area of land, a road, a body of water, and a volume of air above an area of land.

Real world measurable quality may include a measurable quality of a real world object. Examples include, but are not limited to, size, mass, location, direction, velocity, acceleration, pressure, temperature, electric field, magnetic field, and many other physical properties of a real world object.

Real world measurement may include the value of a measurement of a real world measurable quality of a real world object over a real world clock time span, or a composite measurement from a plurality of measurements of a real world measurable quality of a real world object over a real world clock time span, where the value of the composite measurement and the corresponding real world clock time span of the composite measurement are calculated using interpolation, extrapolation, curve fitting, averaging, or some other algorithm, from the plurality of measurements. Examples include, but are not limited to, measurement of the location of a particular vehicle at a particular time, or a plurality of such measurements for the vehicle over a time span, and interpolating between the measurements using the time span to calculate the vehicle position at a particular time within the time span. Example uses of composite measurements include, but are not limited to, obtaining a likely measurement at a time when no measurement was actually made, such as at a time between two measurements, or to increase the accuracy of a measurement by averaging a plurality of measurements, or to increase or decrease the rate of measurements to a desired rate. For instance, a measurement of position of an object made at a rate of 75 times per second may be reduced to a measurement rate of 60 times per second.

Real world event may include a real world clock time span and a set of one or more real world objects, where for each real world object there is set of real world measurements, where the real world clock time span for each real world measurement is within the real world clock time span of the real world event. Examples include a motor sports event, where the position of the participating vehicles are measured at regular intervals during the duration of the event, or a sail boat race, where the position, hull speed, and air speed and direction of the participating boats, and the water current speed and direction at a set of fixed locations, and the air speed and direction at a set of fixed locations, are all measured at regular intervals, during the duration of the event.

Real world measurement based virtual world value may include the virtual world value of a virtual world quality of a virtual world object over a virtual world clock time span, where the virtual world value reflects a real world measurement, and where the virtual world measurable quality corresponds to the real world measurable quality of the real world measurement, and where the virtual world object corresponds to the real world object of the real world measurement, and where the virtual world clock time span corresponds to the real world clock time span of the real world measurement.

Virtual world clock time span may include a span of virtual clock time, bound by a start virtual clock time and an end virtual clock time, within the virtual three dimensional reality of a simulation. The virtual three dimensional reality equivalent to the definition of real world clock time span for the real world. Examples include, but are not limited to, a representation within a simulation of a real world clock time span.

Virtual world object may include a virtual physical object within the virtual three dimensional reality of a simulation. The virtual three dimensional reality equivalent to the definition of real world object for the real world. Examples include, but are not limited to, a representation within a simulation of a real world object, such as a race track, a vehicle, a body of water, a building or other structure, the surface features of an area of land, or a volume of air, or a version of any of those example objects which are not real world objects.

Virtual world measurable quality may include a virtual measurable quality of a virtual world object. The virtual three dimensional reality equivalent to the definition of real world measurable quality for the real world. Examples include, but are not limited to, a representation within a simulation of a real world measurable quality.

Narrative event may include a message that tells the particulars of an act or occurrence, or course of events, or the telling of a story, consisting of a real world event, or a non real world event, where the message is not dependent on interaction of a viewer of a presentation of the message for determination of the message, such as viewer game play, where a video game in particular is excluded as a narrative event.

Event content may include a production collection, which represents a narrative event and is for use by presentation content production to produce presentation content depicting the narrative event, comprising event content core for the narrative event, if any, and event content non-core, if any.

Event content core may include the portion of the event content for a narrative event whose use in unchanged form in presentation content production is required in order for the depiction resulting from the production to be an accurate representation of the narrative event, where for a narrative event which is a real world event the portion of the event content comprises the set of real world measurement based virtual world values for each real world object from the real world event.

Event content non-core may include the portion, if any, of the event content which is not event content core.

### 2.0 Telemetry System

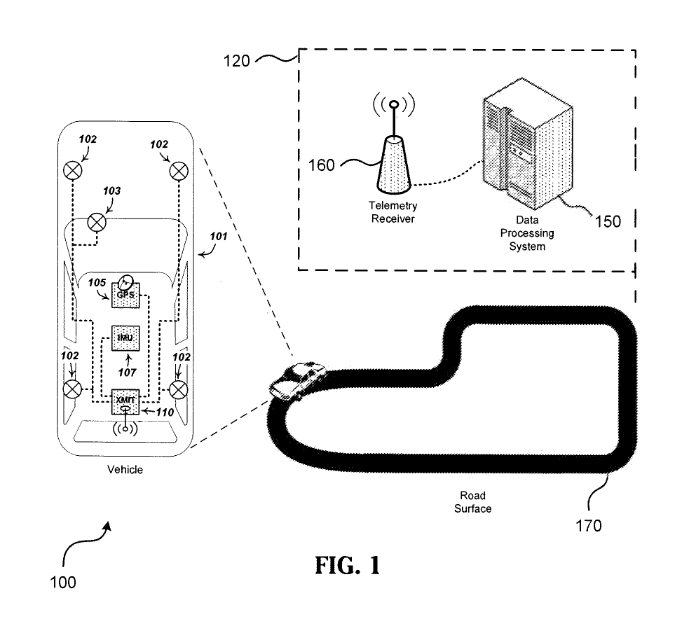

FIG. 1 illustrates an example system 100 where a telemetry system according to one embodiment of the present invention can be implemented. Referring now to FIG. 1, system 100 includes a vehicle 101, a telemetry system 120, and a roadway or track 170. Telemetry system 120 is configured to monitor and collect various data on vehicle 101 as its travel along a road such as track 170 using sensors positioned on vehicle 101 or track 170. According to one embodiment of the present invention, a measurement originated data source or a collection of data generated by telemetry system 120 may have estimated state values supplied by algorithmic inference using some combination of existing data from the measuring device, an external data source, internal and external environmental data, and other suitable data sources such as sensors located on vehicle 101 or track 170.

In a conventional system where data are collected and used, a measurement originated data source may be depended upon by other applications within the system. If the data source is unavailable, it may cause failure or degrade the operation of those dependent applications. In one embodiment, an application such as, for example, a navigation application of vehicle 100 can be configured to operate uninterrupted by providing it with an estimated measurement originated data source when a datum point is missing, erroneous, or otherwise become unavailable for a variety of reasons. In system 100, the estimated data can be provided by telemetry system 120.

A cause of data unavailability may be a failure in some part of the data collection process resulting in the failure to acquire data. Another cause of data unavailability may result from the desire for measurements at certain times over a time interval but the acquired real world measurements only exist at other times over the time interval. An example of this would be a case where real world measurements were acquired at a rate of 10 measurements per second, but where with the use of those measurements, it is preferred to acquired measurements at a rate of 60 measurements per second, so a measurement originated data source is produced by deriving a 60 measurements per second measurement stream from the 10 measurements per second originating measurements using the present invention.

In one embodiment, telemetry system 120 generates a simulated or estimated measurement originated data source by algorithmic inference using data from various sources. A combination of data sources could also be used to generate the simulated data measurement such as, for example, other available measurement originated data sources, data based on knowledge of internal and external environmental properties such as, for example, weather and road conditions. In this way, applications that depend on the measurement originated data source may operate uninterrupted as these applications are provided with an estimated data or simulated measurement originated data source.

In one embodiment, telemetry system 120 is configured to provide increased real or simulated fidelity by algorithmic inferring the increased fidelity using some combination of one or more other available measurement originated data sources, knowledge of the physical circumstances within which the real world measurements, including the originating measurements for the other available measurement originated data sources, is obtained, and other data sources as available. In this way, telemetry system 120 allows for functions dependent on the simulated measurement originated data source within an application to operate with increased real or simulated fidelity.

In one embodiment, telemetry system 120 may use traditional means to detect measurement errors in order to determine whether to use the measurements or to derive estimated measurements. Telemetry system 120 can also be configured to use traditional error correction to recover from measurement errors. In one embodiment, telemetry system 120 attempts to find substantially accurate data to replace the missing data.

In one embodiment, telemetry system 120 has a set of one or more measurement derivation functions to produce each measurement originated data source. In doing so, the measurement derivation function of telemetry system 120 may combine one or more available data sources such as other measurement originated data sources, knowledge, in the form of algorithms and data sets, representing the physical circumstances within which the real world measurements are obtained.

For a measurement originated data source operation including missing measurement mode, the functionality may produce its data source from the originating measurements, but when the originating measurements are unavailable, would produce its data source from one of the available measurement derivation functions. Which measurement derivation function is chosen may depend on a variety of factors, including what other real world measurements are available and other factors.

In one embodiment where telemetry system 120 performs a measurement originated data source operation including a nonexistent measurement mode, the functionality would produce its data source from one of the available measurement derivation functions. The measurement derivation function chosen depends on a variety of factors such as, for example, real world measurements.

In one embodiment, telemetry system 120 performs a measurement originated data source operation in an increased fidelity mode that produces an increased real or simulated fidelity for the data source from one of the available measurement derivation functions. The measurement derivation function chosen depends on a variety of factors such as, for example, real world measurements.

The example applications discussed herein may involve performing real world measurement using telemetry methods, but other real world measurement means, including active and passive remote sensing and other methods of performing real world measurements could also be employed.

In one example application, data of a real world event is captured using real world measurements. The captured data is then used to construct a substantially accurate recreation of the event using a computer simulation. In one embodiment, an automobile driving on a roadway circuit is used as the real world event. As shown in FIG. 1, the automobile represents the event participant, and is equipped with telemetry sensors to capture various aspects of its operation. The roadway represents the immediate event area, and has been digitally mapped or modeled to an appropriate degree. The event recreation may be constructed concurrent with the event, referred to here as a live recreation, so that the computer simulation is simulating the real world events at or near the time the real world events occur. Alternatively, the event recreation may be constructed after the real world event, referred to here as a recorded recreation. Both live and recorded recreations are applicable for the use of the present invention. In this particular example application, the real world measurements are performed using telemetry.

As shown in FIG. 1, vehicle 101 is equipped with a variety of telemeters for measuring various aspects of its operation. Telemeters 102 are positioned at or near each wheel and measure each of the wheels rotation speed. Telemeter 103 measures steer angle, approximately a measure of the angle between the vehicles centerline and the rotational axis of the steer-able wheels, but may be accomplished measuring any part of the component chain from the steering wheel to the steer-able wheels. Telemeter 105 is a GPS unit, or global positioning system unit, measuring the 3-axis position of the vehicle. Telemeter 107 is an inertial measurement unit (IMU), which uses a combination of accelerometers and angular rate sensors to measure: 3-axis acceleration; rate of change of altitude; 3-axis position; velocity; acceleration; and 3-axis altitude. Telemeter 110 can be configured to receive telemetry data from all the other telemeters on the vehicle. Telemetry 110 can also be configured to transmit the telemetry data to a remote telemetry receiver 160. Telemetry receiver 160 can provide the received telemetry to the data processing system 150, a computational device, for further processing and storage.

Data processing system 150 may include functionality for producing and using measurement originated data sources such as measurement derivation. In one embodiment, data processing system 150 may comprise a plurality of computational devices in a plurality of remote locations operating over a plurality of time intervals.

For an application which requires the use of the measurement originated data sources immediately during the real world event, such as a live recreation of the real world event using a computer simulation, the measurement originated data sources, with any measurement derivation, would be produced a short time after the originating measurements, if any, was received, which would be a short time after the corresponding real world event measured by the real world measurements, if any, occurred. For an application which does not require the use of the measurement originated data sources immediately, like a recorded recreation of the real world event using a computer simulation, the data processing system may only record the real world measurements for later processing. Additional processing options are available when producing measurement originated data sources from recorded real world measurements after the real world event, as all real world measurement data is available, past and future at any time in the recorded event, and real-time production constraints do not apply.

In one embodiment, telemetry receiver 160 is positioned in the immediate real world event area, in this case roadway circuit 170. Roadway circuit 170, and possibly additional event area, can be digitally mapped in 3 axes, as well as other mapping as needed, such as roadway surface characteristics. The vehicle can also be digitally mapped and other physical characteristics are measured, such as weight, center of gravity, tire wear, wheel spring and shock response, and engine power curve. In one embodiment, some point relative to the vehicle, and a corresponding point relative to the vehicle map, is chosen as the vehicle coordinate origin. The roadway circuit map positions, positions and altitudes indicated by the vehicle GPS and IMU telemetry, and vehicle coordinate origin are calibrated to correspond with each other, so that the vehicle GPS and IMU positions can be used to determine an accurate vehicle roadway circuit position, or the position of the vehicle coordinate origin relative to the roadway circuit.

Data from the roadway circuit mapping, vehicle mapping, and roadway and vehicle physical characteristics are available to data processing system 150 for use in producing the measurement originated data sources. In one embodiment, data processing system 150 is also provided with functionality to produce the measurement originated data sources, including the set of measurement derivation functions, if any, and the functionality to determine which measurement derivation function to use, if any, for each measurement originated data source. The functionality is typically determined before the real world event begins, as is the mapping and physical characteristic determinations.

One function of data processing system 150 is to produce usable measurement originated data sources. These data sources are provided to other computational devices, not shown, which use the data sources for the construction of the computer simulation of the real world event, which is used to produce the substantially accurate recreation of the real world event.

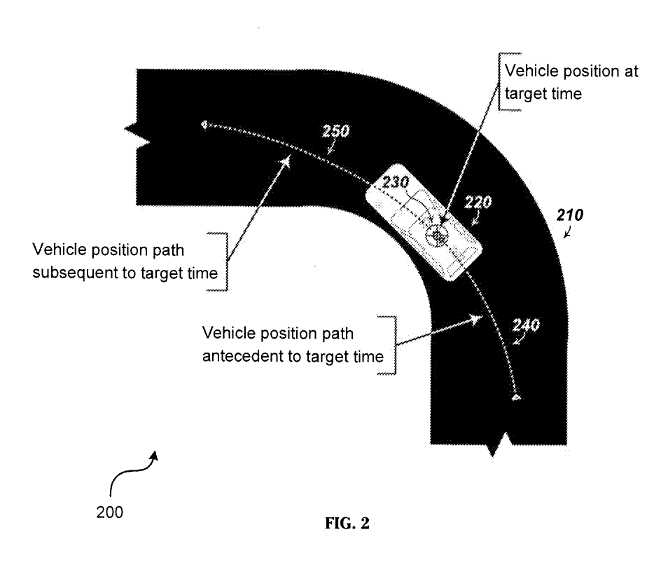

FIG. 2 illustrates a environment 200 in which telemetry system 120 can be implemented according to one embodiment of the present invention. Environment 200 can represent a moment in time, referred to here as the target time, during the real world event being captured. A roadway circuit segment 210 is one of the left turning corners of the roadway circuit. A vehicle 220 is in the process of traveling through the corner. The vehicle coordinate origin 230 of environment 200 indicates the fixed point in space relative to the vehicle which is used as the vehicles 3-axis position point. At the target time vehicle coordinate origin, or vehicle position, is located at a point over the roadway circuit as shown. The antecedent path 240 shows the path the vehicle coordinate origin traveled for a period of time immediately prior to the target time. The subsequent path 250 shows the path the vehicle coordinate origin traveled for a period of time immediately after the target time.

In the case of this scenario, where a steer angle data source is provided, and where steer angle telemetry is missing at, and for some period of time before and after, the target time, or where a steer angle telemeter was not installed and steer angle telemetry is non-existent, the steer angle data source may be estimated using telemetry system 120. Several steer angle estimation derivation methods may be employed using resources available in this example application. It is assumed that this scenario is for a live recreation of the event, where only present and past real world measurements and measurement originated data sources are available. For a recorded recreation, future real world measurements and measurement originated data sources can also be available and may also be used to improve the estimated steer angle. The described derivation methods use various physical properties of the vehicle in their calculations, primarily wheelbase length, but other physical properties may be used in order to improve the estimation, such as front and rear axle width, tire widths, effects suspension travel may have on other physical properties, roadway surface grip, and tire grip.

More sophisticated derivation methods may improve the estimation further by, for example, allowing for effects of the vehicle speed, current estimated roadway surface conditions, and current estimated tire conditions.

In one embodiment, a derivation method of telemetry system 120 estimates a steer angle at the target time by calculating the vehicle turn rate, or turn radius. The vehicle turn rate prior to the target time can be calculated using the vehicle position path immediately prior to the target time as measured by the GPS or IMU. Using this turn rate as the turn rate at the target time, the steer angle necessary to turn the vehicle at this turn rate can then be calculated.

In one embodiment, a derivation method of telemetry system 120 estimates a steer angle at the target time using the vehicle lateral acceleration as measured by the IMU and the vehicle velocity as measured by the GPS or IMU. The steer angle necessary to turn the vehicle at this turn rate is then calculated using the measured lateral acceleration.

In one embodiment, another derivation method of telemetry system 120 estimates a steer angle at the target time using vehicle 120 wheel rotation speeds for each wheel, then calculate the steer angle necessary to turn the vehicle at this turn rate.

Telemetry system 120 may use one or more of these derivation methods, or other derivation methods, or some combination of these derivation methods to calculate the steer angle. When needed, the calculated steer angle can be used as the estimated steer angle or data source to replace missing or non-existent originating measurements. In one embodiment, more than one derivation method may be selected and the result is obtained by averaging.

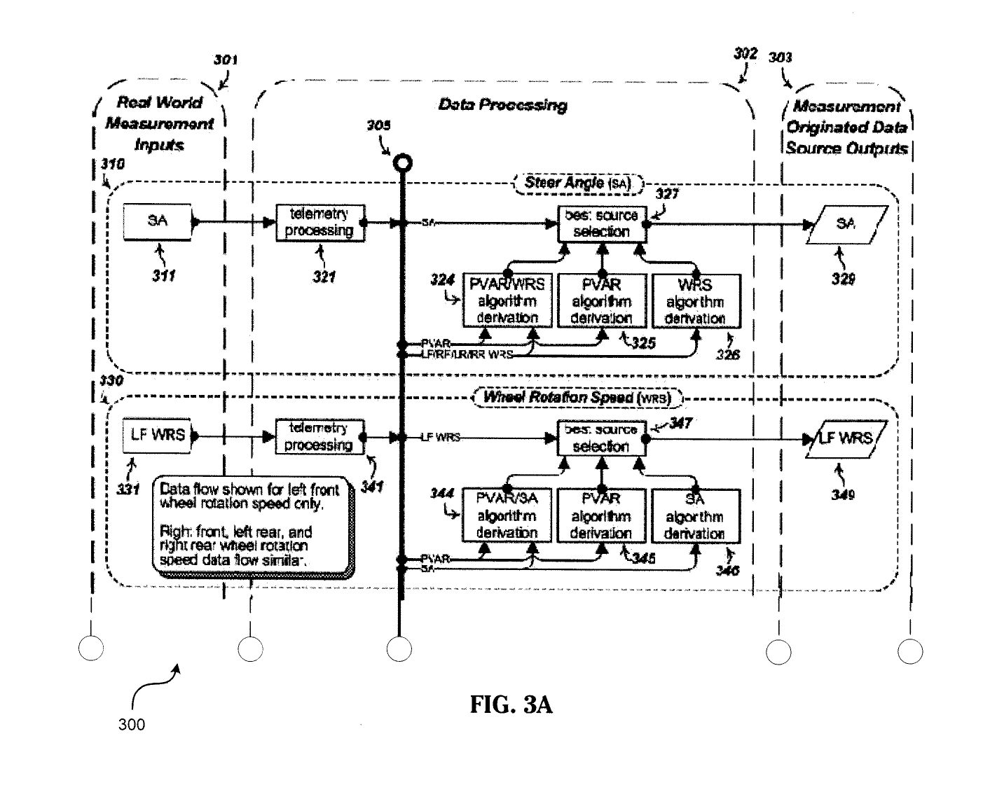

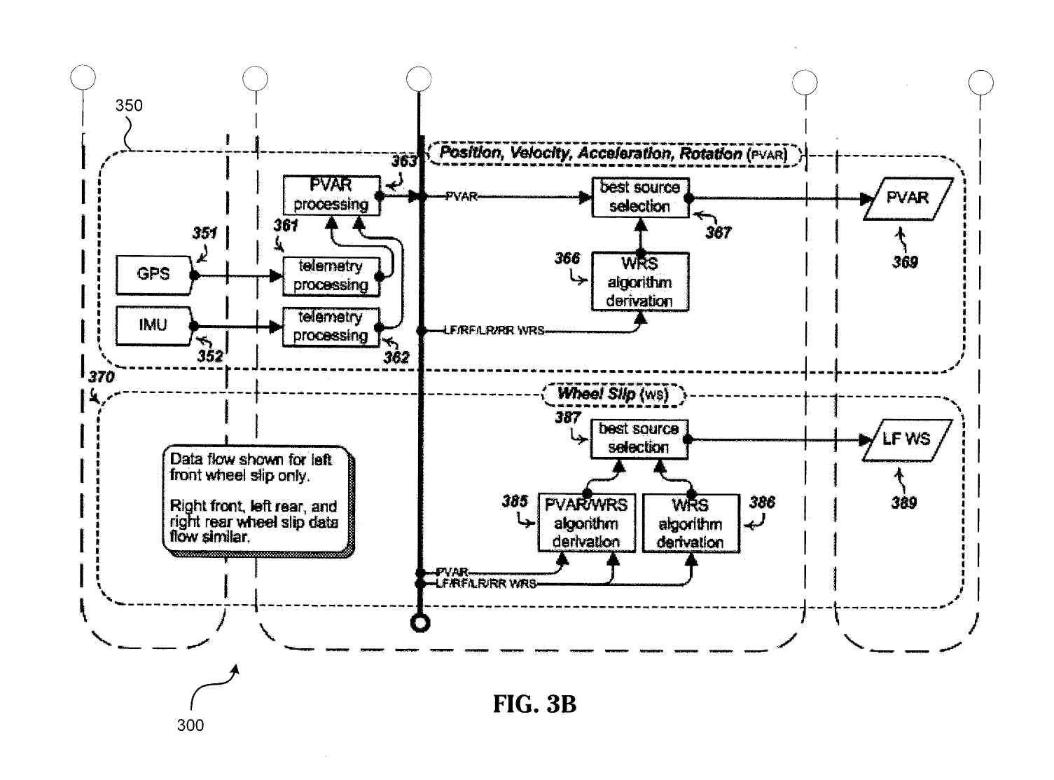

FIG. 3A-B illustrate a data flow 300 from real world measurement data streams to measurement originated data sources according to one embodiment of the present invention. In one embodiment, data flow 300 is contained within and processed by data processing system 150. Referring now to FIG. 3A, a group box 301 may contain the real world measurement data streams as received by data processing system 150. These real world measurement data streams are assumed to be minimally processed from that sent by the telemetry transmitter on the vehicle. A group box 302 may contain the data processing functionality operating on the data processing system which converts the real world measurement data streams to measurement originated data sources usable by other functionality, previously described, and not illustrated here. A group box 303 may contain the measurement originated data sources which are produced from the real world measurement data streams by the illustrated data processing functionality. A data flow box 310 may contain the data flow for the steer angle measurement originated data source. Steer angle is abbreviated as SA in labeling within this figure.

As shown in FIG. 3A, a data flow box 330 may contain the data flow for the left front wheel rotation speed measurement originated data source. Wheel rotation speed is abbreviated as WRS in labeling within this figure. Wheel rotation speed data flow for the right front, left rear, and right rear wheels is similar to the wheel rotation speed data flow for the left front wheel, and is not shown. Abbreviations used within this figure in labeling the four wheels of the vehicle are LF for left front, RF for right front, LR for left rear, and RR for right rear.

Referring now to FIG. 3B, a data flow box 350 may contain the data flow for the position, velocity, acceleration, and rotation measurement originated data source. Position, velocity, acceleration, and rotation is abbreviated as PVAR in labeling within this figure. A data flow box 370 may contain the data flow for the left front wheel slip measurement originated data source. Wheel slip is abbreviated as WS in labeling within this figure, and is a measure of the speed of the tire contact patch over the roadway surface. Wheel slip data flow for the right front, left rear, and right rear wheels is similar to the wheel slip data flow for the left front wheel, and is not shown. In one embodiment, wheel slip measurement originated data sources do not have originating measurements, and the data sources are derived from other real world measurements. Communications bus 305 indicates the processed telemetry, if available, from all real world measurement data streams, and the processed telemetry, if any, availability for use by all data source data processing functionality. Each of the processed telemetry is unavailable when its corresponding originating measurements stream is unavailable.

Certain types of common functional elements may be used in measurement originated data source data flow processing, although the exact functionality necessary to perform a functional element is specific to each individually implemented functional element. These the common functional elements are described here. Real world measurement processing for each real world measurement stream performs operations resulting in a data source usable for the real world measurement stream's described measurement, converting the raw real world measurement stream to a form usable by other functionality, unless the real world measurement stream is unavailable. If the real world measurement stream is available, the processed real world measurements are provided either direct to the communications bus or to other functionality for further processing. If the real world measurement stream is not available, the processed real world measurements are also not available.

In one embodiment, each of the measurement originated data source data flow in the example application includes one or more algorithm derivation functions. In one embodiment, each algorithm derivation function inputs some combination of processed real world measurements, data representing knowledge of the physical circumstances within which real world measurements are obtained, and other data sources as necessary, and operates to derive an estimated measurement originated data source for output.

In telemetry system 120, if the output of an algorithm derivation function is not needed then it may not operate or may operate in an altered state. An algorithm derivation function may not be available to supply its output if some of the information it requires to derive that output is unavailable, such as one of its processed real world measurement inputs. In one embodiment, each measurement originated data source data flow in the example application includes a best source selection function. Each best source selection function selects the source most likely to accurately represent reality to use for the measurement originated data source from among the processed real world measurements from the originating measurements for the measurement originated data source, if available, and one or more estimated measurement originated data sources from algorithm derivation functions. If no source is available, then the measurement originated data source is unavailable.

In one embodiment, the best source selection function selects the highest priority source available, where each source has a fixed priority associated with it, the processed real world measurements having the highest priority.

In one embodiment, steer angle measurement originated data source data flow begins with the input of steer angle telemetry 311 for telemetry processing 321 that produces processed telemetry available for this and other measurement originated data source data flows. A source selection function 327 selects the processed telemetry, if it is available, otherwise choosing one from among the three algorithm derivations, if any are available. In one embodiment, the PVAR/WRS algorithm derivation 324 uses a combination of PVAR processed telemetry and LF, RF, LR, and RR WRS processed telemetry to calculate an estimated current turn radius, then estimating the steer angle required to result in such a turn radius. The other derivation algorithms are similar, where the PVAR algorithm derivation 325 uses only PVAR processed telemetry, and the WRS algorithm derivation 326 uses only WRS processed telemetry. The source selected by the best source selection, if any, is available as the measurement originated data source 329.

Left front wheel rotation speed measurement originated data source data flow begins with the input of left front wheel rotation speed telemetry 331 for telemetry processing 341, producing processed telemetry available for this and other measurement originated data source data flows. In one embodiment, the best source selection function 347 selects the processed telemetry if it is available, otherwise choosing one from among the three algorithm derivations. In one embodiment, the PVAR/SA algorithm derivation 344 uses a combination of PVAR processed telemetry and SA processed telemetry to calculate an estimated current turn radius. The vehicle velocity from the PVAR processed telemetry is then used to estimate the left front wheel rotation speed resulting from such a turn radius and vehicle velocity. The other derivation algorithms are similar, where the PVAR algorithm derivation 345 uses only PVAR processed telemetry, and the SA algorithm derivation 346 uses only SA processed telemetry. The source selected by best source selection function 347 is available as the measurement originated data source 349. Right front, left rear, and right real wheel rotation speed measurement originated data collection or source data flows are similar.

In one embodiment, telemetry system 120 generates position, velocity, acceleration, and rotation measurement originated data using data from GPS telemetry 351 and IMU telemetry 352. As shown in FIG. 3B, data from GPS telemetry 351 is used for telemetry processing 361, and data IMU telemetry 352 is used for telemetry processing 362. PVAR processing 363 is an example of using other available telemetry to provide increased fidelity of a measurement originated data source according to the present invention. This example application uses a combination of GPS and IMU processed telemetry to accomplish increased fidelity, but other examples could also be used, for example, using one or both GPS and IMU processed telemetry in combination with wheel rotation speed processed telemetry.

In one embodiment, PVAR processing inputs such as GPS processed telemetry and IMU processed telemetry are combined according their strengths, weaknesses, and availability of the inputs for increased accuracy, which produces PVAR processed telemetry available for this and other measurement originated data source data flows. Some examples of the strengths and weaknesses may be that the GPS telemetry is more accurate than IMU telemetry over large time spans, but less accurate over small time spans. Thus, for this example, the PVAR processing step may use IMU processed telemetry for short term position, velocity, acceleration, and rotation information, but may correct this information over the long term using GPS telemetry. If one of GPS or IMU telemetry is unavailable, then just the available corresponding processed telemetry is used. If both GPS and IMU telemetry are unavailable, then PVAR processed telemetry is unavailable. The best source selection function 367 selects the processed telemetry if it is available, otherwise choosing the WRS algorithm derivation 366, if available. The WRS algorithm derivation uses a combination of LF, RF, LR, and RR WRS processed telemetry to calculate an estimated vehicle velocity and turn radius, then uses this velocity and turn radius along with past saved position, velocity, acceleration, and rotation measurement originated data source data to estimate the vehicle position, acceleration, and rotation. The source selected by the best source selection, if any, is available as the measurement originated data source 369.

A derivation method useful for estimating measurements where the real world measurable quality exhibits a cyclic nature may be used. This cyclic nature is present in position, velocity, acceleration, and rotation measurements for the present example, with a vehicle performing repeated circuits of a fixed track. In general, some measured state of an object is likely to be similar to the same measured state of the same object in similar circumstances at some other time, or the same measured state of a similar object in similar circumstances. Specifically, in the present example, this can be utilized to supply position, velocity, acceleration, or rotation measurements missing from a portion of a lap using the measurements for the same portion of a lap from the same vehicle but on a different lap, or using the measurements for the same portion of a lap from a different vehicle on any lap. Efforts to maximize the similarity of circumstances between the missing measurements and the replacement measurements will result in improved estimated measurements.

Left front wheel slip measurement originated data source data flow is an example of the production of a measurement originated data source with no originating measurements according to the present invention. There are no telemeters installed in the vehicle to measure wheel slip, but using the present invention a substantially accurate measurement originated data source may be produced. Data flow begins with the best source selection function 387 choosing one from among the two algorithm derivations, if any are available. The PVAR/WRS algorithm derivation 385 uses PVAR processed telemetry to estimate left front wheel rotation speed assuming no wheel slip, then estimating wheel slip using the difference between this estimated wheel rotation speed and the actual left front wheel rotation speed from the LF WRS processed telemetry. The WRS algorithm derivation 386 uses WRS processed telemetry to calculate rotation speed differences between the wheels, then using these speed differences to estimate the non slipping wheels, then using these non slipping wheels rotation speeds to estimate the vehicle speed and turn radius, then using this vehicle speed and turn radius to estimate left front wheel rotation speed assuming no wheel slip, then estimating wheel slip using the difference between this estimated wheel rotation speed and the actual left front wheel rotation speed from the LF WRS processed telemetry. The source selected by the best source selection, if any, is available as the measurement originated data source 389. Right front, left rear, and right rear wheel slip measurement originated data source data flows are similar.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

The term tool can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

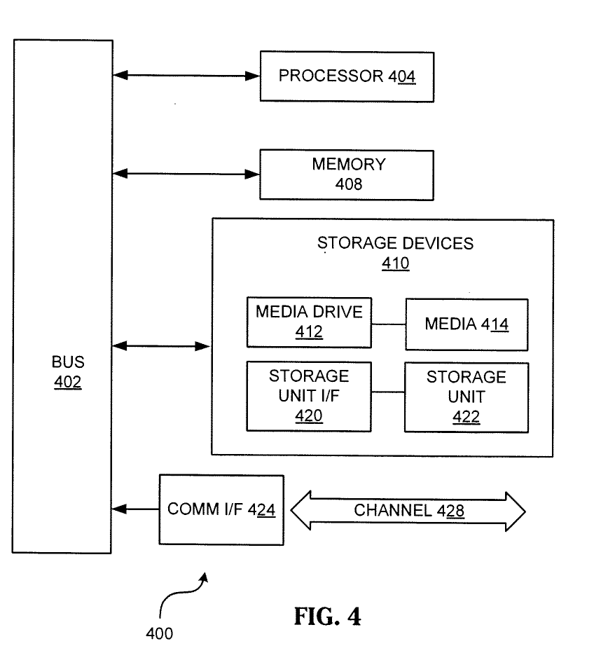

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example-computing module is shown in FIG. 4. Various embodiments are described in terms of this example-computing module 400. In one embodiment, computing module 400 can be configured to implement the functionalities of telemetry system 120. After reading this description, it will become apparent to a person skilled in the relevant art how to implement the invention using other computing modules or architectures.

Referring now to FIG. 4, computing module 400 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, and other electronic devices that might include some form of processing capability.

Computing module 400 might include, for example, one or more processors or processing devices, such as a processor 404. Processor 404 might be implemented using a general-purpose or special-purpose processing engine such as, for example, a microprocessor, controller, or other control logic. In the example illustrated in FIG. 4, processor 404 is connected to a bus 402 or other communication medium to facilitate interaction with other components of computing module 400.

Computing module 400 might also include one or more memory modules, referred to as main memory 408. For example, preferably random access memory (RAM) or other dynamic memory, might be used for storing information and instructions to be executed by processor 404. Main memory 408 might also be used for storing temporary variables or other intermediate information during execution of instructions to be executed by processor 404. Computing module 400 might likewise include a read only memory (“ROM”) or other static storage device coupled to bus 402 for storing static information and instructions for processor 404.

The computing module 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a floppy disk drive, a magnetic tape drive, an optical disk drive, a CD or DVD drive (R or RW), or other removable or fixed media drive. Accordingly, storage media 414, might include, for example, a hard disk, a floppy disk, magnetic tape, cartridge, optical disk, a CD or DVD, or other fixed or removable medium that is read by, written to or accessed by media drive 412. As these examples illustrate, the storage media 414 can include a computer usable storage medium having stored therein particular computer software or data.

In alternative embodiments, information storage mechanism 410 might include other similar instrumentalities for allowing computer programs or other instructions or data to be loaded into computing module 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory module) and memory slot, a PCMCIA slot and card, and other fixed or removable storage units 422 and interfaces 420 that allow software and data to be transferred from the storage unit 422 to computing module 400.

Computing module 400 might also include a communications interface 424. Communications interface 424 might be used to allow software and data to be transferred between computing module 400 and external devices. Examples of communications interface 424 might include a modem or softmodem, a network interface (such as an Ethernet, network interface card, WiMedia, 802.XX or other interface), a communications port (such as for example, a USB port, IR port, RS232 port Bluetooth interface, or other port), or other communications interface. Software and data transferred via communications interface 424 might typically be carried on signals, which can be electronic, electromagnetic, optical or other signals capable of being exchanged by a given communications interface 424. These signals might be provided to communications interface 424 via a channel 428. This channel 428 might carry signals and might be implemented using a wired or wireless medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 408, storage unit 420, media 414, and signals on channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 400 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for the automated production of an estimated state value for a measurement originated data source, comprising:
establishing a relationship between a first part and a second part, wherein components of the first part comprise the estimated state value, a real world object of the estimated state value, a real world measurable quality of the estimated state value, and a real world clock time span of the estimated state value, and
wherein the components of the second part comprise one or more third parts, one or more fourth parts, or both one or more third parts and one or more fourth parts, and
wherein the components of a third part comprise one or more real world measurements of the originating measurements of the measurement originated data source, the real world object and real world measurable quality of the originating measurements, and each real world clock time span of the one or more real world measurements, and
wherein the components of a fourth part comprise one or more state values of an other measurement originated data source, the real world object and real world measurable quality of the other measurement originated data source, and each real world clock time span of the one or more state values of the other measurement originated data source,
such that the estimated state value component of the first part is expressed in terms of the combination of the other components of the first part and the components of any third and fourth part components of the second part.

2. The method of claim 1, wherein the measurement originated data source forms the basis of a set of real world measurement based virtual world values, such that for each real world measurement based virtual world value of the set of real world measurement based virtual world values:
the real world measurement based virtual world value corresponds to a state value of the measurement originated data source, the state value is used for the real world measurement of the real world measurement based virtual world value,
the real world clock time span of the state value is used for the real world clock time span of the real world measurement based virtual world value,
the real world measurable quality of the state value is used for the real world measurable quality of the real world measurement based virtual world value, and
the real world object of the state value is used for the real world object of the real world measurement based virtual world value.

3. The method of claim 2, where the set of real world measurement based virtual world values constitutes a portion of the set of real world measurement based virtual world values of the event content core of the event content of a real world event.

4. The method of claim 3, wherein the relationship is determined in whole or in part by physical interdependence between some or all of the combined components of the first part and the second part.

5. The method of claim 1, wherein the relationship is determined in whole or in part by physical interdependence between some or all of the combined components of the first part and the second part.

6. The method of claim 4, wherein the real world clock time span of said estimated state value is the same as a target real world measurement, wherein said target real world measurement is a real world measurement of the originating measurements of said measurement originated data source, wherein said target real world measurement is not a component of any third part component of said second part, and wherein a comparison between said estimated state value and said target real world measurement forms the basis of a judgment of validity of said target real world measurement.

7. The method of claim 1, wherein the second part includes at least one the third part component, and wherein the real world clock time span of the estimated state value of the first part is different than the real world clock time span of every real world measurement of all third part components of the second part.

8. The method of claim 1, wherein the real world clock time span of said estimated state value is the same as a target real world measurement, wherein said target real world measurement is a real world measurement of the originating measurements of said measurement originated data source, wherein said target real world measurement is not a component of any third part component of said second part, and wherein a comparison between said estimated state value and said target real world measurement forms the basis of a judgment of validity of said target real world measurement.

9. The method of claim 1, wherein the real world clock time span of said estimated state value is the same as a target real world measurement, and wherein said target real world measurement is a real world measurement of the originating measurements of said measurement originated data source, and wherein said target real world measurement is not a component of any third part component of said second part, and wherein said target real world measurement is replaced by said estimated state value.

10. The method of claim 1, wherein the real world clock time span of the estimated state value is the same as a target real world measurement, and wherein the target real world measurement is a real world measurement of the originating measurements of the measurement originated data source; and wherein the target real world measurement is not a component of any third part component of the second part, and wherein the difference between the estimated state value and the target real world measurement forms the basis for determining a delta value, and wherein the target real world measurement is replaced by the sum of the target real world measurement and the delta value.

11. The method of claim 1, where said second part includes no third part component.

12. The method of claim 4, wherein the second part includes at least one the third part component, and where the real world clock time span of the estimated state value of the first part is different than the real world clock time span of every real world measurement of all third part components of the second part.

13. The method of claim 4, where said second part includes no third part component.

14. The method of claim 4, wherein the real world clock time span of the estimated state value is the same as a target real world measurement, and wherein the target real world measurement is a real world measurement of the originating measurements of the measurement originated data source, and wherein the target real world measurement is not a component of any third part component of the second part, and wherein the target real world measurement is replaced by the estimated state value.

15. The method of claim 4, wherein the real world clock time span of the estimated state value is the same as a target real world measurement, and wherein the target real world measurement is a real world measurement of the originating measurements of the measurement originated data source, and wherein the target real world measurement is not a component of any third part component of the second part, and wherein the difference between the estimated state value and the target real world measurement forms the basis for determining a delta value, and wherein the target real world measurement is replaced by the sum of the target real world measurement and the delta value.

16. A method for generating navigational data comprising:
determining whether a replacement data is needed for a datum point of a data stream;
monitoring a characteristic of a vehicle; and
generating a navigational data as the replacement data based on the characteristic of the vehicle, wherein the characteristic of the vehicle is one or more characteristic from the group of a positional information of the vehicle, a lateral acceleration of the vehicle; and a rotational speed of a wheel of the vehicle.

17. The method of claim 16, wherein the navigational data is a steer angle information.

18. The method of claim 16, wherein the positional information comprises a global positioning system positional information or an information generated by an inertia measurement unit located on the vehicle.

19. The method of claim 16, further comprising averaging two or more characteristics of the vehicle to generate the navigational data.

20. The method of claim 19, wherein the characteristic of the vehicle further comprises a velocity of the vehicle or a condition information of a road where the vehicle is located.

21. The method of claim 19, wherein the characteristic of the vehicle further comprises a tire condition information, weight, center of gravity, wheel spring and shock response, an altitude information of the vehicle, or engine power curve.

22. The method of claim 16, wherein the position of the vehicle is determined using an information of a road the vehicle is traveling on.

23. A system having a computer program product configured to perform the method of claim 16.
